(19) United States
(12) Patent Application Publication
(10) Pub. No.: US 2019/0056680 A1
(43) Pub. Date: Feb. 21, 2019

(54) STAGGERED DOCTOR BLADES FOR PRINTERS AND MULTIFUNCTION PERIPHERALS

(71) Applicants: Kabushiki Kaisha Toshiba, Minato-ku (JP); Toshiba TEC Kabushiki Kaisha, Shinagawa-ku (JP)

(72) Inventors: Don W. STAFFORD, Lexington, KY (US); Donn D. BRYANT, Lexington, KY (US); Gary L. NOE, Lexington, KY (US); Michael W. LAWRENCE, Lexington, KY (US)

(21) Appl. No.: 15/679,676

(22) Filed: Aug. 17, 2017

(51) Int. Cl. G03G 15/08

(52) U.S. Cl. CPC G03G 15/0812; G03G 2215/0648; G03G 15/0808

(57) ABSTRACT

A system and method for producing a uniform layer of toner on a developer roller of a toner-based printer includes two or more doctor blades that are configured to reduce the amount of toner deposited on the developer roller in successive steps. A first doctor blade reduces the layer of toner to a first depth, and a second doctor blade further reduces the layer of toner to a second depth. A third or subsequent doctor blade can further reduce the layer of toner to a third depth. An electrical charge applied to one or more of the doctor blades produces a substantially uniform charge to the layer of toner on the developer roller.

### TECHNICAL FIELD

This application relates generally to doctor blades on toner-based electro-photographic printers and multifunction peripherals. The application relates more particularly to a plurality of staggered doctor blades for generating a uniform layer of toner on a developer roller of an electrostatic process unit of a printer.

### BACKGROUND

Document processing devices include printers, copiers, scanners and e-mail gateways. More recently, devices employing two or more of these functions are found in office environments. These devices are referred to as multifunction peripherals (MFPs) or multifunction devices (MFDs). As used herein, MFP means any of the forgoing.

An electrostatic process unit, or EPU, in many printers and multifunction peripherals assists in performing the printing functions. The EPU typically comprises a photoconductive drum, a developer roller, and developer. The EPU can be configured as a field replaceable unit or can be part of a self-contained compact cartridge that includes the toner. Using magnetic and electrostatic forces, the developer roller and the photoconductive drum transfers toner from a toner hopper to a sheet of paper where it is fused by heat to the paper.

However, if the toner is not evenly distributed on the developer roller, or is poorly charged, or has the wrong polarity, then toner can inadvertently end up in the wrong place on the printed page, settle as dust on printer parts that could interfere with the proper operation of an electrostatic process unit, or otherwise accumulate as waste.

### BRIEF DESCRIPTION OF THE DRAWINGS

FIG. 1 is a block diagram of a multifunction peripheral;

FIG. 2 is a block diagram of toner-based printing elements of an example laser printer;

FIG. 3 is a functional diagram of an example embodiment of staggered doctor blades for toner-based print hardware; and

FIG. 4 is a flowchart of example operations for producing a uniformly charged layer of toner on a developer roller of a toner-based printer.

### SUMMARY

In an example embodiment, an apparatus includes two or more doctor blades that are configured to distribute a substantially uniform layer of toner onto a developer roller of a toner-based printer such as a laser printer or multifunction peripheral. A first doctor blade reduces the layer of toner to a first depth, and a second doctor blade further reduces the layer of toner to a second depth. A third or subsequent doctor blade further reduces the layer of toner to the desired depth. In a configuration, one or more of the doctor blades have an electrical charge that produces a substantially uniform charged layer of toner on the developer roller.

In an example embodiment, an electrostatic process unit includes a developer roller that attracts an initial layer of toner from a toner hopper, and two or more doctor blades that reduce the initial layer of toner on the developer roller to a substantially uniform desired depth. The electrostatic process unit can include additional structures such as an electrostatic drum, a primary charge roller, a controllable light source such as a semiconductor laser. A first doctor blade reduces the layer of toner to a first depth, and a second doctor blade further reduces the layer of toner to a second depth. A third or subsequent doctor blade further reduces the layer of toner to the desired depth. In a configuration, one or more of the doctor blades have an electrical charge that produces a substantially uniform charged layer of toner on the developer roller.

In an example embodiment, a method of generating a substantially uniform layer of toner on a developer roller includes attracting toner from a toner hopper onto the developer roller and removing toner to a desired depth by two or more doctor blades. The method can include applying an electrical charge to one or more of the doctor blades to produce a substantially uniform charged layer of toner on the developer roll.

### DETAILED DESCRIPTION

The systems and methods disclosed herein are described in detail by way of examples and with reference to the figures. It will be appreciated that modifications to disclosed and described examples, arrangements, configurations, components, elements, apparatuses, devices methods, systems, etc. can suitably be made and may be desired for a specific application. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such.

In toner-based electro-photographic printers, toner is picked up by a magnetic developer roller from a toner hopper. A precise leveling blade called a doctor blade is positioned close to the magnetic developer roller and removes excess toner to ensure there is only a thin even layer of toner on the magnetic developer roller. The magnetic developer roller rotates towards a photoconductive drum, and toner from the magnetic developer roller is electrostatically attracted to and transferred to the photoconductive drum in accordance with a desired image to be printed. The toner is then transferred from the photoconductive drum and fused with paper to form a printed page. Residual toner that is left on the photoconductive drum is removed by a cleaner blade or wiper blade into a waste bin.

If the toner is poorly charged, or if the toner is the wrong polarity, then toner may not transfer as intended from the magnetic developer roller, to the photoconductive drum, and ultimately to the paper. Stray toner can inadvertently end up on the printed page, settle as dust on printer parts, or otherwise accumulate as waste. The stray toner can interfere with the proper operation of an electrostatic process unit, or EPU, that typically comprises the photoconductive drum, the magnetic developer roller, and developer in a field replaceable unit or a self-contained compact cartridge. Therefore minimizing stray toner can improve the quality of printed images, reduce waste, and lower maintenance costs.

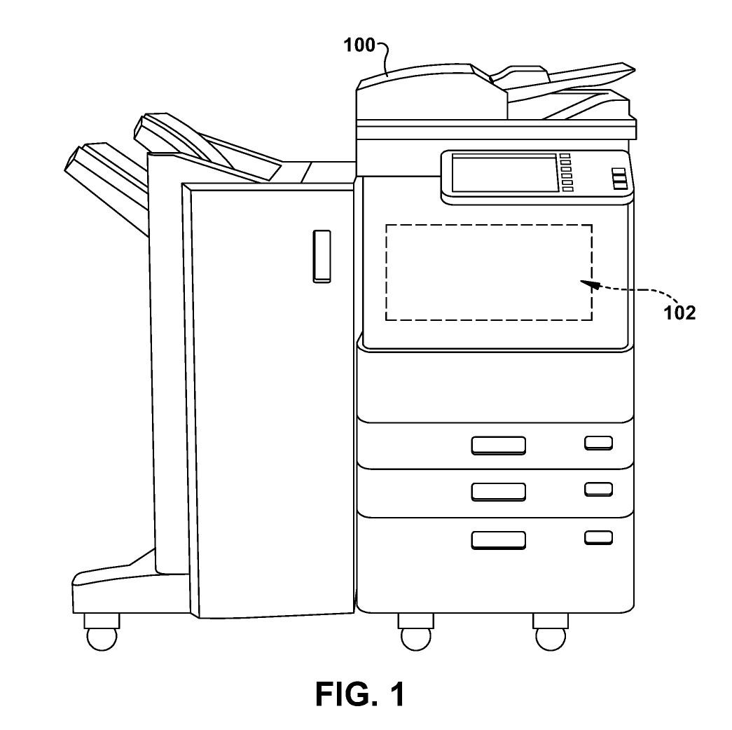

With reference to FIG. 1, an example multifunction peripheral (MFP 100) is presented. The MFP 100 includes electrostatic-based, or toner-based, printing hardware 102 for performing printing operations as would be understood in the art.

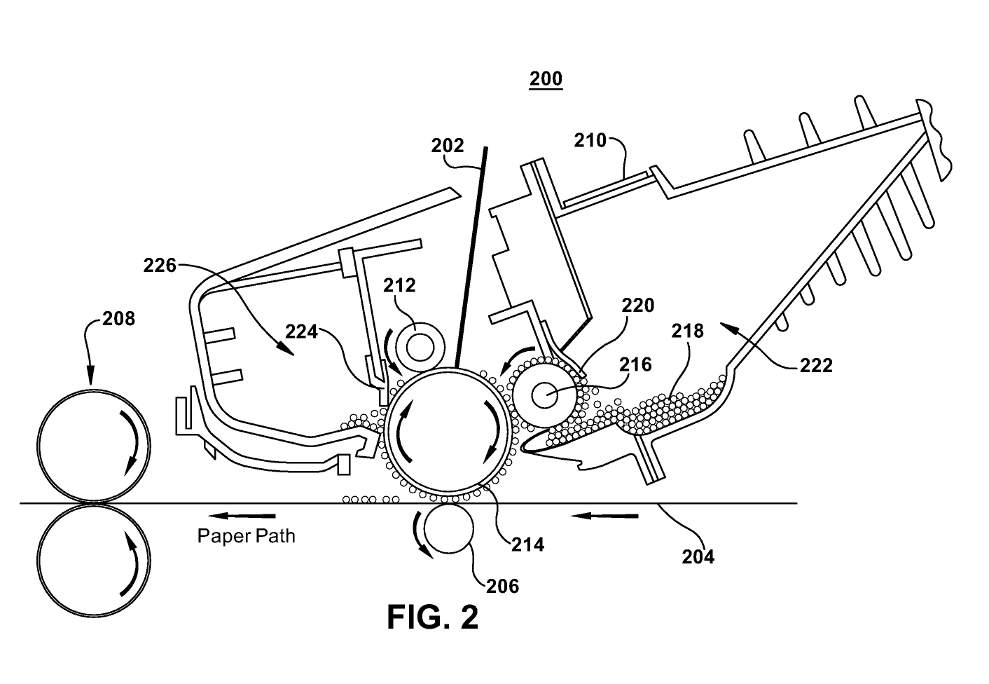

With reference to FIG. 2, a block diagram of toner-based printing hardware 200 of an example laser printer is presented. The hardware 200 includes a laser 202, or other illumination source, that selectively illuminates portions of a photoconductive drum 214 to generate the image to be printed on the paper 204. The hardware 200 can include a field replaceable cartridge 210 that facilitates replacement by the end user. In the cartridge 210, the photoconductive drum 214 receives an initial charge from a primary charge roller or PCR 212. Illumination from the laser 202 selectively changes the charge on the photoconductive drum 214 that determines whether or not portions of the photoconductive drum 214 will attract or repel toner 218. Toner 218 in the toner hopper 222 is attracted to the magnetic developer roller 216. As the magnetic developer roller 216 rotates, a doctor blade 220 removes excess toner 218 from the magnetic developer roller 216 and ensures that toner 218 is evenly distributed to a desired depth on the magnetic developer roller 216. As the magnetic developer roller 216 continues to rotate, toner 218 on the magnetic developer roller 216 is electrostatically attracted to charged portions of the photoconductive drum 214. As the photoconductive drum 214 rotates, toner 218 on the photoconductive drum 214 is electrostatically pulled from the photoconductive drum 214 onto the paper 204 by a charge associated with the transfer roller. The toner 218 on the paper 204 is then heat fused by the fusing assembly 208 to permanently bond the toner 218 to the paper 204. Toner 218 left on the photoconductive drum 214 is scraped from the photoconductive drum 214 by a wiper or cleaner blade 224 and deposited into a waste bin 226.

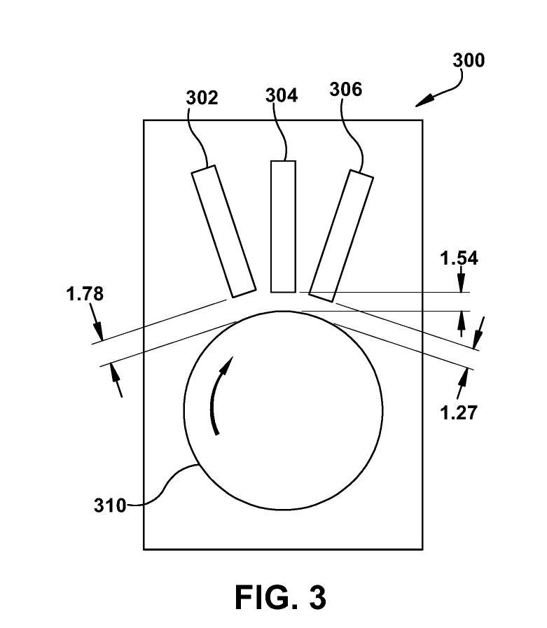

With reference to FIG. 3, a functional diagram of an embodiment of staggered doctor blades 300 for toner-based printing is presented. The staggered doctor blades 300 can comprise two or more doctor blades such as the first doctor blade 302, second doctor blade 304, and third doctor blade 306 as illustrated. The staggered doctor blades 300 are configured to have decreasing displacements from an associated magnetic developer roller 310. For example, the first doctor blade 302 can be positioned approximately 1.78 mm from the magnetic developer roller 310; the second doctor blade 304 can be positioned approximately 1.54 mm from the magnetic developer roller 310; and the third doctor blade 306 can be positioned approximately 1.27 mm from the magnetic developer roller 310. Other suitable displacements can be used as would be understood in the art. The arrangement of staggered doctor blades 300 advantageously reduces the torque on the magnetic developer roller 310 by gradually reducing the toner layer thickness on the magnetic developer roller 310 in multiple steps instead of reducing the toner layer in one step by a single doctor blade, for example as shown in FIG. 2. Also advantageously, gradually reducing the toner layer in multiple steps using the staggered doctor blades 300 can also result in a substantially uniform distribution of toner on the magnetic developer roller 310.

In a configuration, one or more of the doctor blades 300 can be configured to have a charge. For example, a negative voltage such as a −500 VDC to −1500 VDC charge can be applied to one or more of the staggered doctor blades 300. The application of this charge on the staggered doctor blades 300 induces the correct charge on the toner particles as the toner contacts the staggered doctor blades 300. Charging one or more of the staggered doctor blades 300 advantageously results in the toner on the magnetic developer roller 310 having a more uniform charge, and can correct toner that is not charged correctly or that has the wrong polarity. Advantageously, correctly charged toner that has a uniform charge improves print quality, increases the transfer efficiency of toner from the magnetic developer roller to the photoconductive drum, and from the photoconductive drum to the paper (not shown, see for example FIG. 2 and the associated detailed description), reduces the amount of toner that must be removed from the photoconductive drum as waste, and reduces the amount of stray toner that ends up on the printed page or that accumulates as dust insider the printer. Toner that has an incorrect charge, for example a charge that has the wrong polarity, has a tendency to spray into the printer onto printer components, can interfere with proper printer operation, and can require more maintenance and downtime.

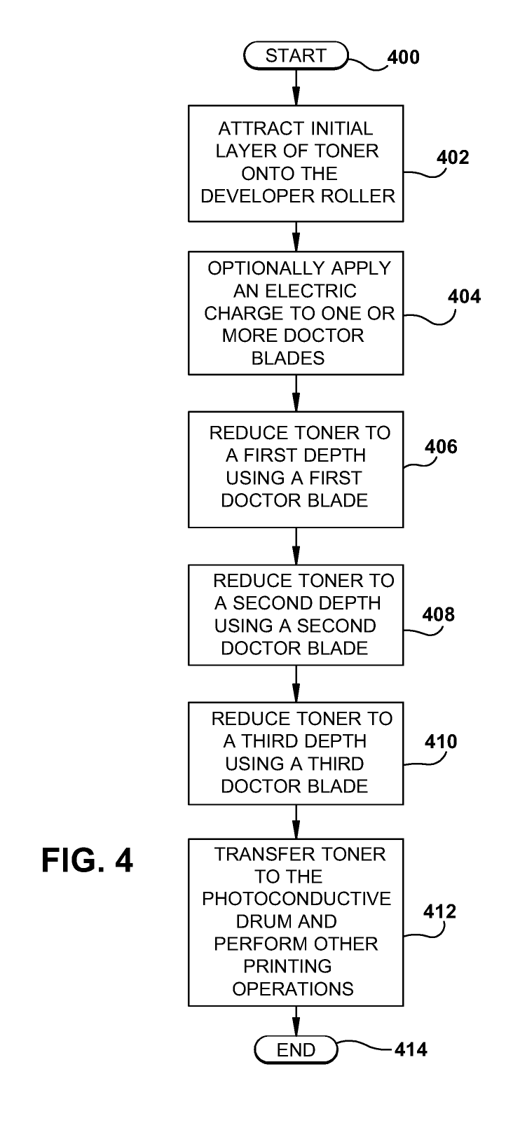

With reference to FIG. 4, an example flowchart for producing a uniformly charged layer of toner on a developer roller of a printer is presented. Processing commences at start block 400 and proceeds to process block 402.

At process block 402, a developer roller attracts an initial layer of toner from a toner hopper. The developer roller can attract the toner magnetically, electrostatically, or through a combination of magnetic and electrostatic forces. Processing continues to process block 404.

At process block 404, one or more doctor blades optionally receive an electrical charge, for example a charge of between approximately −500 VDC and approximately −1500 VDC. The charge ensures that the toner is uniformly charged after process block 406, 408, and 410. Processing continues to process block 406.

At process block 406, the developer roller rotates the toner towards a first doctor blade that reduces the initial layer of toner to a first desired depth, for example 1.78 mm. If the first doctor blade was charged in process block 404, the first doctor blade will induce a uniform charge on the toner as the toner contacts the first doctor blade. Processing continues to process block 408.

At process block 408, the developer roller continues to rotate the toner towards a second doctor blade that further reduces the toner to a second desired depth, for example 1.54 mm. If the second doctor blade was charged in process block 404, the second doctor blade will induce a uniform charge on the toner as the toner contacts the second doctor blade. Processing continues to process block 412.

At process block 410, the developer roller continues to rotate the toner towards a third doctor blade that further reduces the toner to a third desired depth, for example 1.27 mm. If the third doctor blade was charged in process block 404, the third doctor blade will induce a substantially uniform charge on the toner as the toner contacts the third doctor blade. Processing continues to process block 412.

At process block 412, the developer roller continues to rotate and transfers at least a portion of the toner from the developer roller to a photoconductive drum for printing a desired image. Other printing operations are then performed including transferring the toner from the photoconductive drum to paper, and fusing the toner onto the paper. Processing terminates at end block 414

In light of the foregoing, it should be appreciated that the present disclosure significantly advances the art of toner-based printing. While example embodiments of the disclosure have been disclosed in detail herein, it should be appreciated that the disclosure is not limited thereto or thereby inasmuch as variations on the disclosure herein will be readily appreciated by those of ordinary skill in the art. The scope of the application shall be appreciated from the claims that follow.

1. An apparatus, comprising:
a plurality of doctor blades configured to distribute a substantially uniform layer of toner onto a developer roller of a toner-based printer,
wherein a first doctor blade is configured to reduce the layer of toner on the developer roller to a first depth,
wherein a second doctor blade is configured to further reduce the layer of toner on the developer roller to a second depth,
wherein a third doctor blade is configured to further reduce the layer of toner on the developer roller to a third depth, and
wherein the first doctor blade is oriented so as to extend radially from an axis of the developer roller,
wherein the second doctor blade is oriented so as to extend radially from the axis of the developer roller, and
wherein the third doctor blade is oriented so as to extend radially from the axis of the developer roller.

2. (canceled)

3. The apparatus of claim 2, wherein the second doctor blade is displaced closer to the developer roller than the first doctor blade is displaced from the developer roller, and wherein the third doctor blade is displaced closer to the developer roller than the second doctor blade is displaced from the developer roller.

4. The apparatus of claim 3, wherein the first doctor blade is displaced at a distance of approximately 1.78 mm from the developer roller, wherein the second doctor blade is displaced at a distance of approximately 1.54 mm from the developer roller, and wherein the third doctor blade is displaced at a distance of approximately 1.27 mm from the developer roller.

5. The apparatus of claim 1, wherein at least one of the plurality of doctor blades is further configured to apply a charge to the toner to produce a substantially uniform charged layer of toner on the developer roller.

6. The apparatus of claim 5, wherein at least one of the plurality of doctor blades receives a charge lower than −500 VDC but greater than approximately −1500 VDC.

7. An electrostatic process unit, comprising:
a developer roller configured to attract an initial layer of toner from a toner hopper; and
a plurality of three or more doctor blades configured to reduce the initial layer of toner on the developer roller to a substantially uniform desired depth,
wherein each of the plurality of doctor blades is oriented so as to extend radially from an axis of the developer roller.

8. The electrostatic process unit of claim 7, further comprising:
an electrostatic drum configured to selectively attract at least a portion of the toner from the developer roller based on electrostatic charge present on the electrostatic drum;
a primary charge roller configured to place a substantially uniform electric charge on the electrostatic drum; and
a controllable light source configured to selectively modify the electrostatic charge on the electrostatic drum in accordance with a desired image to be printed.

9. The electrostatic process unit of claim 7, wherein a first doctor blade is configured to reduce the layer of toner on the developer roller to a first depth, and wherein a second doctor blade is configured to further reduce the layer of toner on the developer roller to a second depth.

10. The electrostatic process unit of claim 9, wherein a third doctor blade is configured to further reduce the layer of toner on the developer roller to a third depth.

11. The electrostatic process unit of claim 10, wherein the plurality of doctor blades are staggered doctor blades that are each displaced at a different distance from the developer roller than the other doctor blades.

12. The electrostatic process unit of claim 11, wherein the first doctor blade is displaced at a distance of approximately 1.78 mm from the developer roller, wherein the second doctor blade is displaced at a distance of approximately 1.54 mm from the developer roller, and wherein the third doctor blade is displaced at a distance of approximately 1.27 mm from the developer roller.

13. The electrostatic process unit of claim 7, wherein at least one of the plurality of doctor blades is configured to apply a charge to the toner to produce a substantially uniform charged layer of toner on the developer roller.

14. The electrostatic process unit of claim 13, wherein at least one of the plurality of doctor blades is configured to receive a charge lower than −500 VDC but greater than approximately −1500 VDC.

15. A method of generating a substantially uniform layer of toner on a developer roller, comprising:
attracting toner from a toner hopper onto the developer roller; and
removing, by three or more doctor blades each of which is oriented so as to extend radially from an axis of the developer roller, toner to a desired depth on the developer roller.

16. The method of claim 15, wherein a first doctor blade removes toner to a first desired depth on the developer roller, and wherein a second doctor blade removes toner to a second desired depth on the developer roller.

17. The method of claim 16, wherein a third doctor blade removes toner to a third desired depth of the developer roller.

18. The method of claim 17, wherein the first doctor blade is displaced at a distance of approximately 1.78 mm from the developer roller, wherein the second doctor blade is displaced at a distance of approximately 1.54 mm from the developer roller, and wherein the third doctor blade is displaced at a distance of approximately 1.27 mm from the developer roller.

19. The method of claim 15, further comprising:
applying a charge to at least one of the plurality of doctor blades to produce a substantially uniform charged layer of toner on the developer roller.

20. The method of claim 19, wherein at least one of the plurality of doctor blades receives a charge lower than −500 VDC but greater than approximately −1500 VDC.
